SEQUENCE LISTING (1 sequence)

SEQ ID NO: 1 - protein, 208 aa, Artificial Sequence
  Chemically synthesized amino acid sequence
RELEELNVPGEIVESLSSSEESITCINKKIEKFQSEEQQQTEDELQDKIHPFATQTSLVYPFPGPIPDSLPQNIPPLTQTPVVVPPIQPEVMGVSKVKEAMAPKHKEMPFPKYPVEPFTESQSLTLTDVEDLHLPPLLLQSWMHQPHQPLPPTVMFPPQSVLSLSQSKVLPVPQKAVPYPQRDMPIQAFLLYQEPVLGPVRGPFPIIV

(19) United States
(12) Patent Application Publication
(10) Pub. No.: US 2009/0285936 A1
(43) Pub. Date: Nov. 19, 2009

(54) NEW FUNCTIONAL FERMENTED MILK (YOGURT) FOR USE IN DIETING

(76) Inventor: Sang Lee Han, Seoul (KR)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/307,162

(22) PCT Filed: Jul. 3, 2007
(86) PCT No.: PCT/KR2007/003211

§ 371 Date: Dec. 31, 2008

(30) Foreign Application Priority Data
Jul. 3, 2006 (KR) 10-2006-0062109

(51) Int. Cl. A23C 9/12

(52) U.S. Cl. 426/61

(57) ABSTRACT

The present invention is to provide a lactic acid bacteria-fermented composition having an excellent dietary function, which is prepared by lactic acid fermentation of milk containing beta-casein-H. The lactic acid bacteria-fermented composition is prepared by fermenting a mixture of: milk containing beta-casein-H; lactic acid bacteria for fermenting said milk; and oligosaccharide. The functional, lactic acid bacteria-fermented composition has a refreshing and sour flavor and a plain taste and, at the same time, shows an excellent dietary function, because it is prepared by fermenting milk containing beta-casein-H, instead of fermenting general milk. When the fermented composition is ingested by mice or rats, it provides a weight loss of about 11% compared to mice or rats, which did not ingest it. Thus, the fermented composition has a greatly improved weight loss effect and exhibits an excellent dietary function.

### TECHNICAL FIELD

The present invention relates to a lactic acid bacteria-fermented composition for dietary use, which is prepared by lactic acid fermentation of milk containing beta-casein-H.

### BACKGROUND ART

Recently, due to rapid industrialization and westernized eating habits, obese or overweight persons have rapidly increased. Obesity is a risk factor which causes various adult diseases, including hypertension, diabetes, coronary artery disease, palsy, gall bladder trouble, uterine cervix cancer, breast cancer, prostate cancer and colon cancer. Particularly, persons who are overweight or obese sometimes undergo psychological and mental pains due to social prejudice and discrimination, and thus overweight or obesity become social problems.

Conventional treatments of obesity include various methods, such as diet therapy using low-calorie and/or low-fat diets, behavior modification therapy, drug therapy or surgical therapy. Diet therapy, which is most generally used, is carried out using low-calorie food while controlling the amount of the food, shows weight loss effect, but has shortcomings in that the taste of food is reduced, and sufficient calories required for daily life cannot be obtained. Particularly, the so-called yo-yo effect, where overeating occurs to regain lost weight due to an increase in appetite, is pointed out as a problem. Surgical therapies include liposuction of removing fat from the body using a strong force, ultrasonic liposuction of sucking fat by lysing fat cells using ultrasonic waves, and rotary liposuction which uses a general suction device. However, such surgical therapies cause a side effect of getting bruises or making the skin surface rough and have a problem in that they can risk the life of patients due to excessive bleeding. To improve such problems, various dietary methods have been developed in various fields. A lactic acid bacteria-fermented composition according to the present invention is a lactic acid bacteria-fermented food having an excellent weight loss effect and can exhibit an excellent dietary effect without causing side effects.

Lactic acid bacteria, which are generally used, are broadly classified into three categories: Lactobacillus, Streptococcus and Bifidobacterium. Lactobacillus bacteria are lactic acid bacteria, which are most frequently used in the industrial field, and include L. bulgaricus, L. casei, L. acidophillus and the like. Among them, L. casei Shirota bacteria are special lactic acid bacteria having strong acid tolerance help intestinal regulation and digestion, and thus are very beneficial to the human body. Also, such bacteria do not die in digestive juices and bile in the human body, are active mainly in the small intestine, and have the effects of normalizing intestinal microflora in the small intestine and stabilizing the colon. L. acidophilus bacteria have strong acid tolerance, have the effect of inhibiting spoilage microorganisms in the intestines, an anticancer effect and the effect of lowering cholesterol levels, and have the ability to synthesize group-B vitamin. Streptococcus bacteria are characterized in that they have an excellent ability to produce lactic acid and are sensitive to antibiotics. Also, these bacteria well grow at a temperature higher than 40° C., unlike other lactic acid bacteria, which well grow at 37° C., and typical examples thereof include Streptococcus thermophilus. Bifidobacterium bacteria are active mainly in the colon to normalize colon bacteria, but are difficult to culture, because their auxotrophy is very complex such that they are killed in the presence of oxygen. Pathogenic microorganisms such as E. coli cannot be used for the proliferation of Bifidobacterium, but available oligosaccharides are used in the culture of Bifidobacterium.
Among lactic acid fermented compositions obtained by fermenting milk using such lactic acid bacteria, interest in functional fermented milk has increased. Fermented milks are divided, according to the kind of lactic acid bacteria used in fermentation, into fermented milk having the effects of regulating the intestines and inhibiting Helicobacter pylori known to cause duodenal ulcer, and functional fermented milk having an effect on the prevention of hepatic dysfunction and liver disease. Such functional fermented milk is characterized in that the function thereof is varied depending on the bacterial strain used in the fermentation thereof, unlike the lactic acid bacteria-fermented composition.

### DISCLOSURE OF INVENTION

### Technical Problem

It is an object of the present invention to provide a lactic acid bacteria-fermented composition for dietary use, which is prepared by lactic acid fermentation of milk containing beta-casein-H having a specific amino acid sequence, has a taste and function, which are distinguishable from products obtained by fermenting general milk, and particularly shows an excellent weight loss effect.

In the case of the above-described prior various milks fermented with lactic acid bacteria, the function thereof is determined by probiotics according to the kind of bacterial strain. However, according to the present invention, a lactic acid bacteria-fermented composition, having a good taste and flavor, and particularly an excellent weight loss effect, which are determined depending on the properties of amino acids or specific peptides utilized by lactic acid bacteria, is provided by fermenting milk, which contains beta-casein-H, unlike general milk.

### Technical Solution

According to the present invention, a functional, lactic acid bacteria-fermented composition having a dietary effect is prepared by fermenting a mixture of: milk containing beta-casein-H; lactic acid bacteria for fermenting said milk; and oligosaccharide.

A method for preparing the functional, lactic acid bacteria-fermented composition having an excellent dietary effect, according to the present invention, comprises the steps of: adding an oligosaccharide to milk containing beta-casein-H and sterilizing the mixture; cooling the milk/oligosaccharide mixture; inoculating the milk with lactic acid bacteria for fermenting the milk; culturing the lactic acid bacteria in the milk; and, after the culturing step, cooling the culture medium at pH 3.8 to pH 4.2 to terminate the fermentation of the milk.

### Advantageous Effects

The lactic acid bacteria-fermented composition according to the present invention shows an excellent dietary effect, because it is prepared by fermenting the milk containing beta-casein-H.

Various vitamins, amino acids and specific peptides are required for the growth of lactic acid bacteria. Because the beta-casein-H, which is used in the present invention, has an amino acid sequence different from that of the casein of general milk, it has a structure and function different from those of the prior general milk and can very specially act in the growth of lactic acid bacteria. Thus, the probiotics of the lactic acid bacteria-fermented composition have been found and prepared using the beta-casein-H with a characteristic amino acid sequence, and have a dietary function, thereby reaching the present invention.

That is, the characteristics of the lactic acid bacteria-fermented composition according to the present invention are not determined by the kind of lactic acid bacterial strain used, but rather by the amino acid composition and peptide structure of milk, which are required for the growth of lactic acid bacteria. As a result, the present invent, a functional, lactic acid bacteria-fermented composition have been developed for dietary use, which has a good taste, flavor, viscosity and color, and particularly an excellent weight loss effect.

### BRIEF DESCRIPTION OF THE DRAWINGS

FIG. 1 is a graphic diagram showing weight loss as a function of time (month) for rats which ingested yogurt prepared from milk containing beta-casein-H.

FIG. 2 is a graphic diagram showing a weight loss as a function of time (month) for mice which ingested yogurt prepared from milk containing beta-casein-H.

### MODE FOR THE INVENTION

Hereinafter, a preferred embodiment of the present invention will be described in further detail with reference to the accompanying drawings. Prior to this, the terms or words used in the specification and claims are not limited to usual or dictionary meaning, but the present invention should be understood by the meaning or concepts matching to the technical spirits of the present invention on the basis of such principles that the scope of the term can be properly defined to explain the present invention with the best method by the inventor.

Thus, since the embodiments described in the present specification and the construction described on the accompanying drawings are only the preferred embodiments, but do not represent for all technical aspects of the present invention, it should be understood that various equivalents and modification examples exist for replacing with the technical aspects of the present invention at the time of filing the present invention.

As disclosed in Korean Patent Registration Nos. 10-0221124 and 10-0140248, the milk containing beta-casein-H can be obtained after beta-casein-H is confirmed through DNA sequence analysis, amino acid sequence analysis or electrophoresis of a protein degradation product.

The sequence of beta-casein-H according to one embodiment of the present invention is as follows:

Arg-Glu-Leu-Glu-Glu-Leu-Asn-Val-Pro-Gly-Glu-Ile-
Val-Glu-(p)Ser-Leu-(p)Ser-(p)Ser-(p)Ser-Glu-Glu-
Ser-Ile-Thr-Cys-Ile-Asn-Lys-Ile-Glu-Lys-Phe-Gln-
Ser-Glu-Glu-Gln-Gln-Gln-Thr-Glu-Asp-Glu-Leu-Gln-
Asp-Lys-Ile-His-Pro-Phe-Ala-Gln-Thr-Gln-Ser-Leu-
Val-Tyr-Pro-Phe-Pro-Gly-Pro-Ile-Pro-Asp-Ser-Leu-
Pro-Gln-Asn-Ile-Pro-Pro-Leu-Thr-Gln-Thr-Pro-Val-
Val-Val-Pro-Pro-Phe-Ile-Gln-Pro-Glu-Val-Met-Gly-
Val-Ser-Lys-Val-Lys-Glu-Ala-Met-Ala-Pro-Lys-His-
Lys-Glu-Met-Pro-Phe-Pro-Lys-Tyr-Pro-Val-Glu-Pro-
Phe-Thr-Glu-Ser-Gln-Ser-Leu-Thr-Leu-Thr-Asp-Val-
Glu-Asp-Leu-His-Leu-Pro-Pro-Leu-Leu-Leu-Gln-Ser-
Trp-Met-His-Gln-Pro-His-Gln-Pro-Leu-Pro-Pro-Thr-
Val-Met-Phe-Pro-Pro-Gln-Ser-Val-Leu-Ser-Leu-Ser-
Gln-Ser-Lys-Val-Leu-Pro-Val-Pro-Gln-Lys-Ala-Val-
Pro-Tyr-Pro-Gln-Arg-Asp-Met-Pro-Ile-Gln-Ala-Phe-
Leu-Leu-Tyr-Gln-Glu-Pro-Val-Leu-Gly-Pro-Val-Arg-
Gly-Pro-Phe-Pro-Ile-Ile-Val.

In the above sequence, (p)Ser indicates phosphorylated serine, and Arg-Glu-Leu-Glu-Glu-Leu-Asn-Val-Pro-Gly-Glu-Ile-Val-Glu-(p)Ser-Leu-(p)Ser-(p)Ser-(p) Ser-Glu-Glu-Ser-Ile-Thr-Cys-Ile-Asn-Lys, which is the amino acid sequence of the N-terminal end, corresponds to casein phosphopeptide-H(CPP—H).

In the amino acid sequence of beta-casein-H as compared to the amino acid sequence of the prior beta-casein A² variant, arginine (Arg) at position 25 is substituted by cysteine (Cys), leucine (Leu) at position 88 by isoleucine (Ile), glutamine (Gln) at position 117 by glutamate (Glu), glutamate (Glu) at position 175 by glutamine (Gln), and glutamine (Gln) at position 195 by glutamate (Glu). In addition, serine at position 22 may be phosphorylated. Phosphorylated serine is known to have an effect on the solubilization of inorganic ions such as calcium and iron.

Particularly, a phosphorylated serine at position 15, three successive phosphorylated serines at positions 17 to 19 and connected two glutamic acid residues form a strong anionic site, which provides an active site to calcium. That is, caseins form a dimer via 25^{th} Cys residue from the N-terminal end, or CPPs which are formed from digestion of casein, form a dimer. Because the active site is stabilized due to the formation of the dimer, the stability of beta-casein-H or peptide increases, thereby showing an excellent ability to solubilize minerals, compared to the prior CPPS.

To the milk containing beta-casein-H, obtained as described above, oligosaccharide is added to be 2% to 6%, and then the milk is sterilized at 85-95° C. for 15 minutes.

The sterilized milk is cooled to a temperature of 35-40° C., and then inoculated with lactic acid bacteria. In this regard, the lactic acid bacteria consist of a blend of 5-6 bacterial strains belonging to three families, Lactobacillus, Streptococcus and Bifidobacterium. These lactic acid bacteria are added for fermentation or probiotic purposes. The inoculated bacterial strains are cultured at 35-40° C. for 6-18 hours, and as the culture medium reaches about pH 3.8 to 4.2, the culturing step is terminated, followed by cooling.

The lactic acid bacteria-fermented composition prepared through the above-described process has a characteristic taste and flavor and an excellent dietary function, due to special probiotics, compared to those prepared from general milk.

The reason is that, while various vitamins, amino acids and specific peptides are required for the growth of lactic acid, the beta-casein-H, which is used in the present invention, peculiarly acts in the growth of lactic acid bacteria, because it has an amino acid composition and peptide structure different from those of the casein of general milk. As a result, the lactic acid bacteria-fermented composition shows an excellent dietary effect. Also, the beta-casein-H is characterized in that it is stable in strongly acidic conditions, because it has lower isoelectric point (pH 4.2) than that of general casein.

In order to check the excellent dietary effect of the lactic acid bacteria-fermented composition according to the present invention, the weight loss effect thereof was measured. For this purpose, mice and rats as test animals were acclimated to an environment by breeding them for 10 days in a laboratory animal pre-breeding facility in College of Animal Bioscience and Technology, Konkuk University, Korea. Then, the animals were divided into ten groups having the same average weight, each group consisting of five animals, and then were tested. Test diet groups were divided into a diet group, which was allowed to ingest yogurt obtained by fermenting milk containing beta-casein-H, and a diet group fed only with general feed. The feed had a composition, comprising more than 18% of crude protein, more than 5.0% of crude fat, less than 5% of crude fiber, less than 8.0% of crude ash and less than 3.0% of minerals, and the animals were allowed ad libitum access to food for 5 months. During the breeding period, the diet intake was measured daily at a given point of time, and the weight was measured one time a week.

Table 1 below shows the changes in weight as a function of time (month) for rats, which ingested yogurt prepared from milk containing beta-casein-H, and rats which did not ingest the yogurt.

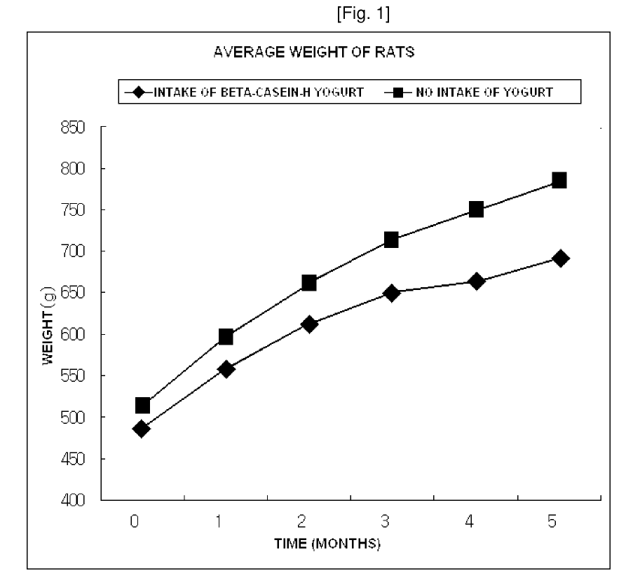

As shown in Table 1, in the case of the rats which were allowed to eat the yogurt prepared from the milk containing beta-casein-H, the weight increased by 70.56 g one month after the start of the test, 54.88 g two months, 37.96 g three months, 13.79 g four months and 26.62 g five months, indicating that the weight increased by a total of 203.81 g for five months and a monthly average of 40.762 g, whereas, in the case of the rats which did not ingest the yogurt, the weight increased by 83.83 g one month after the start of the test, 65.00 g two months, 51.90 g three months, 35.23 g four months and 34.18 g five months, indicating that the weight increased by a total of 270.14 g for five months and a monthly average of 54.028 g. Thus, the rats, which were allowed to eat the yogurt prepared from the milk containing beta-casein-H, showed a weight increase rate of 41.81%, which indicates a weight loss effect of about 11% compared to that (52.64%) of the rats which did not ingest the yogurt. This suggests that, when a 60 kg body weight person ingests the yogurt prepared from the milk containing beta-casein-H, a weight loss of about 7 kg is obtained. This indicates that the composition of the present invention is very effective in losing weight. The numerical values in Table 1 were plotted as a graph in FIG. 1. In addition, the rats, which ingested the yogurt prepared from the milk containing beta-casein-H, were much smaller in size than the rats, which did not ingest the yogurt.

TABLE 1

| | Average weight | |
|---|---|---|
| | Average weight of rats which | Average weight of rats which |
| Elapsed time(month) | ingested beta-casein-H yogurt | did not ingest yogurt |
| 0 month (start) | 487.50 | 513.17 |
| 1 month | 558.06 | 597.00 |
| 2 months | 612.94 | 662.00 |
| 3 months | 650.90 | 713.90 |
| 4 months | 664.69 | 749.13 |
| 5 months | 691.31 | 783.31 |
| Weight gain (gram) | 203.81 | 270.14 |
| Weight increase rate (%) | 41.81 | 52.64 |

Table 2 below shows the changes in weight as a function of time (month) for mice, which ingested yogurt prepared from milk containing beta-casein-H, and mice which did not ingest the yogurt.

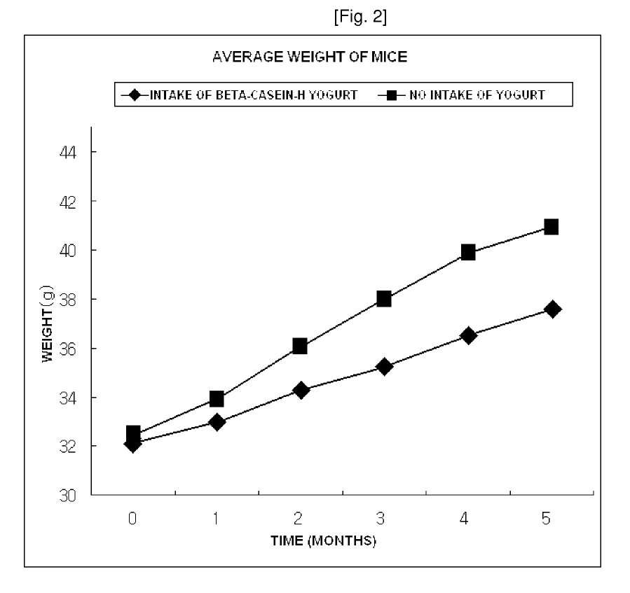

As shown in Table 2, in the case of the mice which were allowed to eat the yogurt prepared from the milk containing beta-casein-H, the weight increased by 0.83 g one month after the start of the test, 1.29 g two months, 0.99 g three months, 1.24 g four months and 1.07 g five months, indicating that the weight increased by a total of 5.42 g for five months and a monthly average of 0.084 g, whereas, in the case of the mice which did not ingest the yogurt, the weight increased by 1.45 g one month after the start of the test, 2.18 g two months, 1.90 g three months, 1.91 g four months and 1.05 g five months, indicating that the weight increased by a total of 8.49 g for five months and a monthly average of 1.698 g. Thus, the mice, which were allowed to eat the yogurt prepared from the milk containing beta-casein-H, showed a weight increase rate of 16.85%, which indicates a weight loss effect of about 10% compared to that (26.16%) of the mice which did not ingest the yogurt. This suggests that, when a 60 kg body weight person ingests the yogurt prepared from the milk containing beta-casein-H, a weight loss of about 6 kg is obtained. This indicates that the composition of the present invention is very effective in losing weight. The numerical values in Table 1 were plotted as a graph in FIG. 2. Also, the mice, which ingested the yogurt prepared from the milk containing beta-casein-H, were much smaller in size than the mice, which did not ingest the yogurt.

TABLE 2

| | Average weight | |
|---|---|---|
| | Average weight of mice which | Average weight of mice which |
| Elapsed time(month) | ingested beta-casein-H yogurt | did not ingest yogurt |
| 0 month (start) | 32.15 | 32.46 |
| 1 month | 32.98 | 33.91 |
| 2 months | 34.27 | 36.09 |
| 3 months | 35.26 | 37.99 |
| 4 months | 36.50 | 39.90 |
| 5 months | 37.57 | 40.95 |
| Weight gain (gram) | 5.42 | 8.49 |
| Weight increase rate (%) | 16.85 | 26.16 |

The lactic acid bacteria-fermented composition for dietary use according to one embodiment of the present invention may further comprise functional materials such as dietary fiber.

According to the present invention, the lactic acid bacteria-fermented composition for dietary use can be used to prepare, for example, frozen yogurt, cheese, confectionery or dressing.

Although the preferred embodiment of the present invention has been described for illustrative purposes, those skilled in the art will appreciate that various modifications, additions and substitutions are possible, without departing from the scope and spirit of the invention as disclosed in the accompanying claims.

1. A lactic acid bacteria-fermented composition for dietary use, comprising:
milk containing beta-casein-H;
lactic acid bacteria for fermenting said milk; and
oligosaccharide.

2. The composition of claim 1, wherein the beta-casein-H has an amino acid sequence as follows:
Arg-Glu-Leu-Glu-Glu-Leu-Asn-Val-Pro-Gly-Glu-Ile-
Val-Glu-(p)Ser-Leu-(p)Ser-(p)Ser-(p)Ser-Glu-Glu-
Ser-Ile-Thr-Cys-Ile-Asn-Lys-Lys-Ile-Glu-Lys-Phe-
Gln-Ser-Glu-Glu-Gln-Gln-Gln-Thr-Glu-Asp-Glu-Leu-
Gln-Asp-Lys-Ile-His-Pro-Phe-Ala-Gln-Thr-Gln-Ser-
Leu-Val-Tyr-Pro-Phe-Pro-Gly-Pro-Ile-Pro-Asp-Ser-
Leu-Pro-Gln-Asn-Ile-Pro-Pro-Leu-Thr-Gln-Thr-Pro-
Val-Val-Val-Pro-Pro-Phe-Ile-Gln-Pro-Glu-Val-Met-
Gly-Val-Ser-Lys-Val-Lys-Glu-Ala-Met-Ala-Pro-Lys-
His-Lys-Glu-Met-Pro-Phe-Pro-Lys-Tyr-Pro-Val-Glu-
Pro-Phe-Thr-Glu-Ser-Gln-Ser-Leu-Thr-Leu-Thr-Asp-
Val-Glu-Asp-Leu-His-Leu-Pro-Pro-Leu-Leu-Leu-Gln-
Ser-Trp-Met-His-Gln-Pro-His-Gln-Pro-Leu-Pro-Pro-
Thr-Val-Met-Phe-Pro-Pro-Gln-Ser-Val-Leu-Ser-Leu-
Ser-Gln-Ser-Lys-Val-Leu-Pro-Val-Pro-Gln-Lys-Ala-
Val-Pro-Tyr-Pro-Gln-Arg-Asp-Met-Pro-Ile-Gln-Ala-
Phe-Leu-Leu-Tyr-Gln-Glu-Pro-Val-Leu-Gly-Pro-Val-
Arg-Gly-Pro-Phe-Pro-Ile-Ile-Val.

3. The composition of claim 1 or 2, wherein the lactic acid bacteria include a blend of bacterial strains belonging to Lactobacillus, Streptococcus or Bifidobacterium.

4. The composition of claim 1 or 2, further comprising dietary fiber.

5. The composition of claim 1 or 2, which is used to prepare frozen yogurt, cheese, confectionery or dressing.
